(19) United States
(12) Patent Application Publication
(10) Pub. No.: US 2015/0088864 A1
(43) Pub. Date: Mar. 26, 2015

(54) INFORMATION PROCESSING DEVICE, INFORMATION PROCESSING METHOD, AND PROGRAM

(71) Applicant: Sony Corporation, Tokyo (JP)

(72) Inventors: Shoichiro Takigawa, Nagano (JP); Mitsuru Waku, Nagano (JP); Takeshi Fujiki, Nagano (JP)

(73) Assignee: Sony Corporation, Tokyo (JP)

(21) Appl. No.: 14/387,902

(22) PCT Filed: Mar. 27, 2013
(86) PCT No.: PCT/JP2013/058970

§ 371 Date: Sep. 25, 2014

(30) Foreign Application Priority Data
May 18, 2012 (JP) 2012-114550

(51) Int. Cl. G06F 17/30; G06F 7/24

(52) U.S. Cl. CPC G06F 17/3084; G06F 17/30867; G06F 7/24
USPC 707/722; 707/780; 707/754

(57) ABSTRACT

There is provided an information processing device including a storage section, a candidate acquiring section configured to acquire candidates of a related term corresponding to an input term, and a related term determining section configured to determine the related term from the candidates of the related term on basis of information stored in the storage section.

### TECHNICAL FIELD

The present disclosure relates to an information processing device, an information processing method, and a program.

### BACKGROUND ART

Generally known search systems execute various searches using the term input by a user as a search key. For example, the technology to search for a program using the term input by the user as the search key is known with regard to the search system of television program information.

The television program information is the electrical program guide (EPG) that is periodically delivered, and presents the broadcast scheduled date of the program, the time slot, the channel, the program name, the cast, the detailed information relevant to the program, and the others, for each program. The search system can search for the program including the term from the EPG on the basis of the term input by the user, and present the searched broadcast scheduled date, time, and the others of the program, as a search result.

Here, the following Patent Literatures 1 and 2 are proposed with regard to the search system of the television program information. Patent Literature 1 discloses the method for producing and displaying the program listing according to the preference information of the user judged on the basis of the view history and the like. Also, Patent Literature 2 discloses the technology in which the link between the programs related to each other is produced in advance, and if a predetermined keyword indicating the link is included in the program content (text information), the keyword is displayed in a distinguishable manner from other texts.

### CITATION LIST

### Patent Literature

Patent Literature 1: JP 2000-287144A

Patent Literature 2: JP 2000-341598A

### SUMMARY OF INVENTION

### Technical Problem

However, the search system of the television program information described above is a search system that is effective only when the user knows the term included in the targeted program. When the targeted program is so ambiguous that the user does not know the term clearly, it is difficult to search for the targeted program with the search system described above.

Also, in the search system described in Patent Literature 1, since the program listing is produced on the basis of the preference information of the user of the past, the information relevant to the program that the user is currently targeting is not considered at all.

Also, in the search system described in Patent Literature 2, the keyword optimized for the user individually is not provided, but the link of the related program is produced on the basis of the keyword to which the user has no connection.

Therefore, the present disclosure proposes a novel and improved information processing device, an information processing method, and a program capable of customizing for each user, and determining, the related term corresponding to the input term.

### Solution to Problem

According to the present disclosure, there is provided an information processing device including a storage section, a candidate acquiring section configured to acquire candidates of a related term corresponding to an input term, and a related term determining section configured to determine the related term from the candidates of the related term on basis of information stored in the storage section.

According to the present disclosure, there is provided an information processing method including a step of acquiring candidates of a related term corresponding to an input term, and a step of determining the related term from the candidates of the related term on the basis of information stored in a storage section.

According to the present disclosure, there is provided a program for causing a computer to function as a storage section, a candidate acquiring section configured to acquire candidates of a related term corresponding to an input term, and a related term determining section configured to determine the related term from the candidates of the related term on basis of information stored in the storage section.

### Advantageous Effects of Invention

As described above, according to the present disclosure, the related term corresponding to the input term is customized for each user, and determined.

### BRIEF DESCRIPTION OF DRAWINGS

FIG. 1 is a diagram for describing an overview of a search system according to an embodiment of the present disclosure.

FIG. 2 is a block diagram illustrating a configuration of an information processing device 1 according to the present embodiment.

FIG. 3 is a block diagram illustrating a configuration of a server 2 according to the present embodiment.

FIG. 4 is a flowchart illustrating a search process according to the present embodiment.

FIG. 5 is a flowchart illustrating an extraction process of related term candidates according to the present embodiment.

FIG. 6A is a screen transition diagram illustrating the first specific example of a result display screen according to the present embodiment.

FIG. 6B is a screen transition diagram illustrating the first specific example of the result display screen according to the present embodiment.

FIG. 7 is a diagram illustrating a display example of a search result according to the present embodiment.

FIG. 8 is a diagram illustrating the second specific example of a result display screen according to the present embodiment.

FIG. 9 is a diagram illustrating the third specific example of a result display screen according to the present embodiment.

FIG. 10 is a diagram illustrating the fourth specific example of a result display screen according to the present embodiment.

FIG. 11 is a diagram illustrating the fifth specific example of a result display screen according to the present embodiment.

FIG. 12 is a diagram illustrating a candidate display example of a search start term according to the present embodiment.

FIG. 13 is a diagram illustrating a candidate display example of a search start term according to the present embodiment.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Also, description will be made in the following order.

1. Overview of Search System according to One Embodiment of Present Disclosure

### 2. Basic Configuration

2-1. Configuration of Information Processing Device

2-2. Configuration of Server

### 3. Action Process

3-1. Search Process

3-2. Extraction Process of Related Term Candidates

### 4. Specific Example of Result Display Screen

4-1. First Specific Example

4-2. Second Specific Example

4-3. Third Specific Example

4-4. Fourth Specific Example

4-5. Fifth Specific Example

### 5. Supplement

### 6. Conclusion

<1. Overview of Search System according to One Embodiment of Present Disclosure>

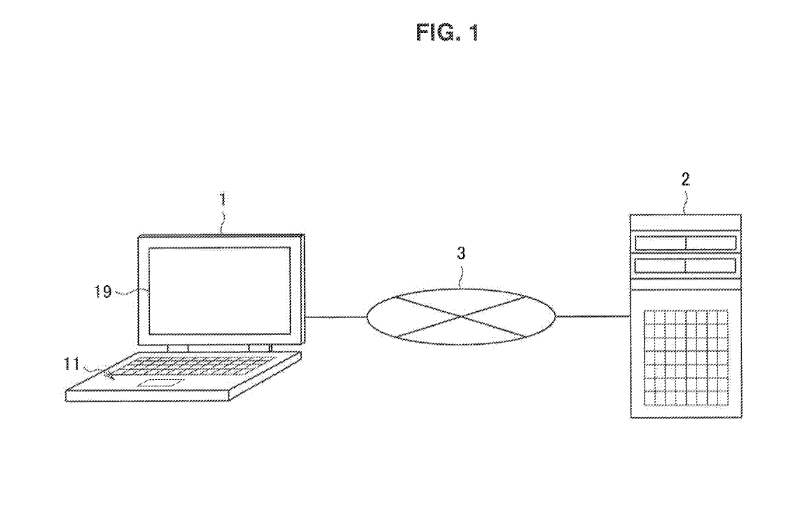

First, description will be made of an overview of a search system according to an embodiment of the present disclosure, with reference to FIG. 1. As illustrated in FIG. 1, the search system according to an embodiment of the present disclosure includes an information processing device 1 (a client terminal) and a server 2. The information processing device 1 connects with the related term candidate extraction server (hereinafter, the server) 2 via a network 3, and transmits and receives the data.

In this search system, the information processing device 1 according to the present embodiment searches for the broadcast scheduled program from the stored EPG for example, on the basis of the term input from the manipulation section such as a keyboard and a touch pad, and displays the search result on the display section 19.

Here, as described above, when the targeted program is so ambiguous that the user (user) does not know the term clearly, normal search systems have had a difficulty in searching for the targeted program based on the input term only.

Therefore, the search system according to the embodiment of the present disclosure has been created in view of the above circumstance. The search system according to the embodiment of the present disclosure is capable of customizing for each user (user) and determining the related term corresponding to the input term in order to conduct a search on the basis of the input term and the related term.

In the following, detailed description will be made of the search system according to an embodiment of the present disclosure. Note that, in FIG. 1, the notebook personal computer (PC) is depicted as one example of the information processing device 1 (the client terminal), but the information processing device according to the present disclosure is not limited to this. The information processing device according to the present disclosure may be, for example, a desktop PC, a smartphone, a personal digital assistants (PDA), a cellular phone, a portable music player device, a portable video processing device, or a portable gaming machine.

Also, the information processing device 1 illustrated in FIG. 1 is the information processing device having the display function (the display section 19), but the display function and the function to execute the search system according to the present disclosure may be realized by separate devices. For example, the information processing device according to the present disclosure may be the information processing device (the search execution function) that connects with the television (the display function).

### <2. Basic Configuration>

### [2-1. Configuration of Information Processing Device]

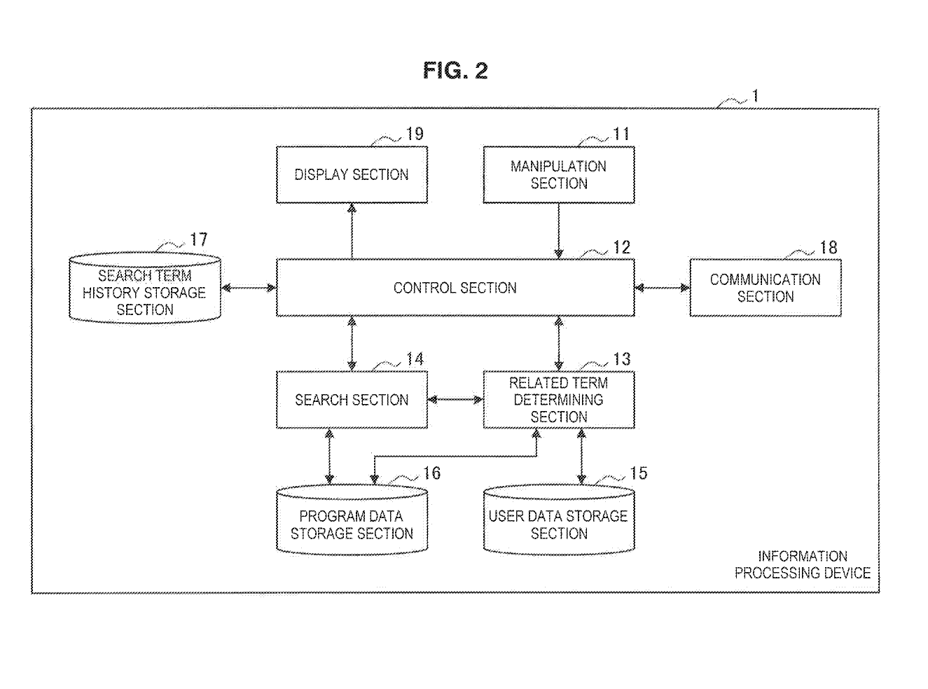

FIG. 2 is a block diagram illustrating the configuration of the information processing device 1 according to the present embodiment. As illustrated in FIG. 2, the information processing device 1 according to the present embodiment includes a manipulation section 11, a control section 12, a related term determining section 13, a search section 14, a user data storage section 15, a program data storage section 16, a search term history storage section 17, a communication section 18, and a display section 19.

### (Manipulation Section)

The manipulation section 11 detects the manipulation by the user, and outputs the manipulation to the control section 12 as the input signal. The manipulation section 11 may be a physical configuration such as a keyboard, a mouse, a button, and a touch pad, and may be a touch panel to detect the manipulation by the user to the display screen. In the present embodiment, the manipulation section 11 accepts the input of the term by the user, for example.

### (Control Section)

The control section 12 controls each component of the information processing device 1. Specifically, the control section 12 controls to transmit the input term input by the user from the manipulation section 11, to the server 2 via the communication section 18. Also, the control section 12 outputs the related term candidates acquired from the server 2 by the communication section 18, to the related term determining section 13.

Also, the control section 12 has the function as the display control section to control the display section 19, and controls to display the result display screen (the search result display screen) including the term used in the search and the search result, for example. Note that the specific examples of the result display screen according to the present embodiment will be described in “4. Specific Example of Result Display Screen”.

Also, the control section 12 outputs the term used in the search to the search term history storage section 17.

### (Communication Section)

The communication section 18 is a communication interface that connects with other communication devices with or without wire to transmit and receive the data. In the present embodiment, the communication section 18 connects with the server 2 via the network 3 to transmit the input term to the server 2. Also, the communication section 18 according to the present embodiment serves as the candidate acquiring section that acquires (receives) the related term candidates corresponding to the input term, from the server 2.

### (Related Term Determining Section)

The related term determining section 13 determines the related term to be used in the search, from the related term candidates on the basis of the user specific data. The user specific data is the data relevant to the user which is stored in the user data storage section 15, and the electronic program listing data that differs depending on the residential area of the user, which is stored in the program data storage section 16.

More specifically, the related term determining section 13 may conduct the matching of the program viewing history data stored in the user data storage section 15, the program recording history data, the favorite genre value, the schedule information and the others, with each related term candidate, in order to determine the related term on the basis of the matching rate and others. Note that the favorite genre value may be the genre value of high view frequency counted on the basis of the program viewing history data of the user. The related term determining section 13 may compare the genre value added to the related term candidate with the user's favorite genre value, in order to determine the related term.

Also, the related term determining section 13 may determine the related term on the basis of the matching rate, the search hit rate, and the like of each related term candidate, to the electronic program listing data, the program metadata, and the like, which differs depending on the user's residential area stored in the program data storage section 16.

In this way, the related term determining section 13 according to the present embodiment can customize for each user and determine the related term to be used in the search, from among the related term candidates corresponding to the input term, which the user has input. The related term determining section 13 outputs the determined related term to the search section 14.

Note that the related term determining section 13 determines an indirectly related term to be used in the search on the basis of the user specific data in the same way, when a related term related to the related term (hereinafter, an indirectly related term) candidate is acquired.

### (User Data Storage Section)

The user data storage section 15 stores the data relevant to the user. The data relevant to the user is, for example, program viewing history data, program recording history data, a favorite genre value, schedule information, a residential area, and the like.

### (Program Data Storage Section)

The program data storage section 16 stores the electronic program listing data, the program metadata, the recorded program data, and others. Note that the electronic program listing data and others stored in the program data storage section 16 may be the electronic program listing data and the like corresponding to the residential area of the user. Also, the recorded program data is the moving image data and the metadata of the program that has already been recorded.

### (Search Section)

The search section 14 conducts the program search through the program data storage section 16, on the basis of the related term determined by the input term and the related term determining section 13. Specifically, the search section 14 conducts the extraction of the program data including the input term (the search based on the input term) and the extraction of the program data including at least the input term or the related term (the search based on the related term), in order to output each as a search result to the control section 12.

Also, when the indirectly related term is determined by the related term determining section 13, the search section 14 extracts the program data including at least the related term or the indirectly related term (the search based on the indirectly related term), in order to output the program data as a search result to the control section 12.

### (Search Term History Storage Section)

The search term history storage section 17 stores the term that the search section 14 has used in the search (the input term, the related term, or the indirectly related term), as the search term.

### (Display Section)

The display section 19 is, for example, a display device such as a liquid crystal display (LCD) device and an organic light emitting diode (OLED) device.

The display section 19 according to the present embodiment displays the result display screen in response to the control by the control section 12 (the display control section). The result display screen includes the input term, the search result based on the input term, the related term, and the search result based on the related term. Also, the result display screen may double as the search term input interface. In other words, the input term, the related term, or the indirect term included in the result display screen can be pointed as the term for the new search, so as to realize the consecutive search by the consecutive pointing of the term. Note that the specific example of the result display screen according to the present embodiment will be described in “4. Specific Example of Result Display Screen”.

### [2-2. Configuration of Server]

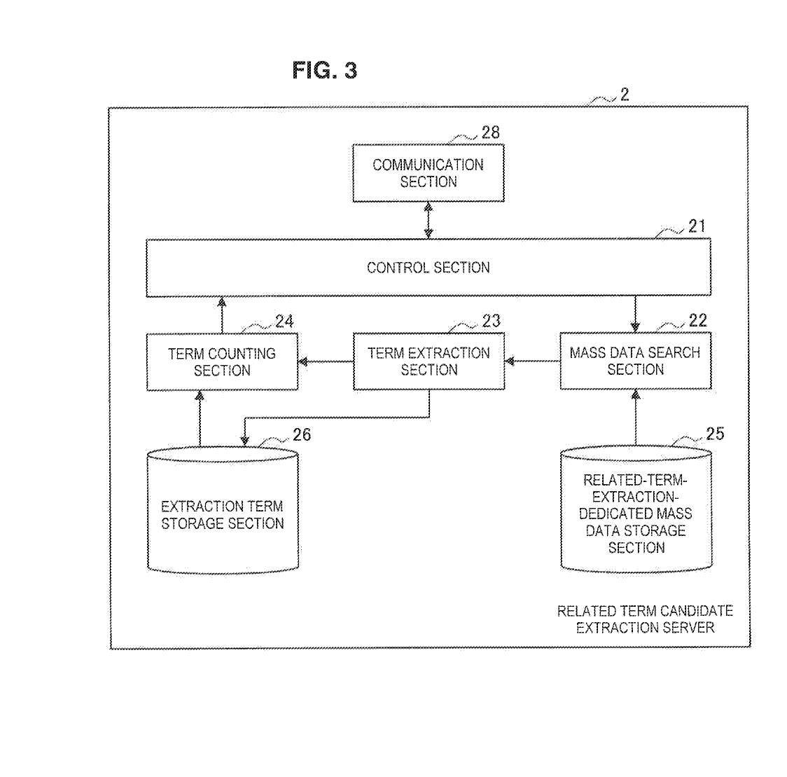

Next, description will be made of the configuration of the related term candidate extraction server 2 according to the present embodiment, with reference to FIG. 3. FIG. 3 is a block diagram illustrating the configuration of the server 2 according to the present embodiment. As illustrated in FIG. 3, the server 2 includes a control section 21, a mass data search section 22, a term extraction section 23, a term counting section 24, a related-term-extraction-dedicated mass data storage section 25, an extraction term storage section 26, and a communication section 28.

### (Communication Section)

The communication section 28 is a communication interface that connects with other communication devices with or without wire to transmit and receive the data. In the present embodiment, the communication section 28 connects with the information processing device 1 via the network 3, and receives the input term. Also, the communication section 18 according to the present embodiment transmits the related term candidates corresponding to the input term to the information processing device 1.

### (Control Section)

The control section 21 controls each component of the information processing device 1. In the present embodiment, the control section 21 controls to extract the related term candidates corresponding to the input term received from the information processing device 1 by the communication section 28, from the accumulated mass data, using a specific algorithm.

Although the specific algorithm for extracting the related term candidates is not particularly limited, the control section 21 may extract the related term candidates on the basis of the processing of the mass data search section 22, the term extraction section 23, and the term counting section 24, which are subsequently described, for example.

Specifically, the control section 21 may extract the terms of the appearance number equal to or more than a predetermined value as the related term candidates, on the basis of the appearance number (or the appearance frequency rate) of each term output from the term counting section 24, for example. Also, the control section 21 may extract the preset number of terms as the related term candidates in the order from the term having the largest appearance number.

Also, the related term candidates extracted by the control section 21 may incorporate the attribute of the genre that the term belongs to (the information indicating the noun of which genre).

### (Mass Data Search Section)

The mass data search section 22 searches for the data including the input term, from the mass data stored in the related-term-extraction-dedicated mass data storage section 25. The mass data search section 22 outputs the searched data to the term extraction section.

### (Related-Term-Extraction-Dedicated Mass Data Storage Section)

The related-term-extraction-dedicated mass data storage section 25 stores the mass data utilized to extract the related term candidates. In the present embodiment, the mass data may be various news sites, television program listing sites, and the like. Also, the mass data stored in the related-term-extraction-dedicated mass data storage section 25 is continually updated, to grow by taking in the newest data.

### (Term Extraction Section)

The term extraction section 23 conducts the morphological analysis to the data that the mass data search section 22 has searched for, in order to extract the term and store the extracted term in the extraction term storage section 26.

### (Term Counting Section)

The term counting section 24 makes an inquiry to the extraction term storage section 26, and calculates the appearance number (or the appearance frequency rate) of each term extracted from the data including the input term, on the basis of the stored extraction term. Also, the term counting section 24 outputs the appearance number (or the appearance frequency rate) of each calculated term to the control section 21.

### <3. Action Process>

### [3-1. Search Process]

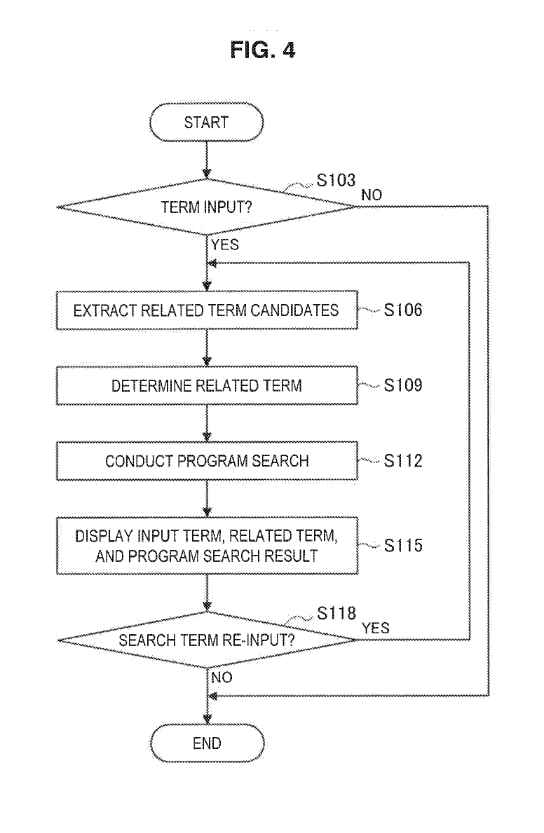

Next, description will be made of the action process of the search system according to the present embodiment, with reference to FIG. 4. FIG. 4 is a flowchart illustrating the action process of the search system according to the present embodiment.

As illustrated in FIG. 4, first, if a term is input from the manipulation section 11 of the information processing device 1 (S103/Yes), the information processing device 1 extracts (acquires) the related term candidates corresponding to the input term (S106). The information processing device 1 may acquire the related term candidates from the server 2. The extraction process of the related term candidates by the server 2 will be specifically described in “3-2. Extraction Process of Related Term Candidates”.

Thereafter, the related term determining section 13 of the information processing device 1 determines the related term to be used in the search, from the related term candidates, on the basis of the user specific data (S109).

Next, the search section 14 of the information processing device 1 conducts the program search through the program data storage section 16 on the basis of the determined related term and the input term (S112).

Thereafter, the control section 12 (the display control section) of the information processing device 1 controls to display the result display screen including the input term, the program search result based on the input term, the related term, the program search result based on the related term, on the display section 19 (S115).

Subsequently, if the search term is input again (S118/Yes), the information processing device 1 repeats the above S106 to S115.

### [3-2. Extraction Process of Related Term Candidates]

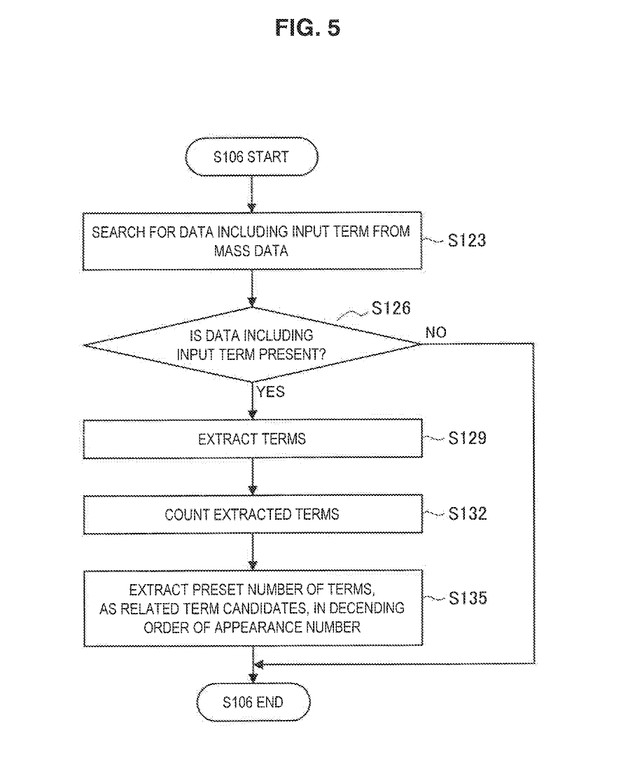

Next, description will be made of the extraction process of the related term candidates shown in step S106 of FIG. 4 described above, with reference to FIG. 5. FIG. 5 is a flowchart illustrating a related term candidate extraction process according to the present embodiment.

As illustrated in FIG. 5, first, the mass data search section 22 of the server 2 searches for the data including the input term, from the mass data stored in the related-term-extraction-dedicated mass data storage section 25 (S123).

Thereafter, if the data including the input term is searched for (S126/Yes), the term extraction section 23 extracts the terms from the searched data, and causes the extraction term storage section 26 to store the extracted terms (S129).

Next, the term counting section 24 makes an inquiry to the extraction term storage section 26, and counts the appearance number of each term extracted from the data including the input term, on the basis of the stored extraction term (S132).

Then, the control section 21 extracts the preset number of terms as the related term candidates, in descending order of the appearance number, in response to the appearance number of each term counted by the term counting section 24 (S135).

As described above, in the search system according to the present embodiment, the program search is conducted using the related term that is related to the input term input by the user and is determined on the basis of the user specific data (customized for each user).

The search system according to the present embodiment can search for the targeted program by conducting the search on the basis of the related term corresponding to the input term, even when an ambiguous term is input by the user for whom the targeted program is unclear. Also, the search system according to the present embodiment customizes the related term to be used in the search for each user, in order to realize the program search optimized for each user.

### <4. Specific Example of Result Display Screen>

Next, description will be made of the result display screen according to the present embodiment, with the first to fifth specific examples.

### 4-1. First Specific Example

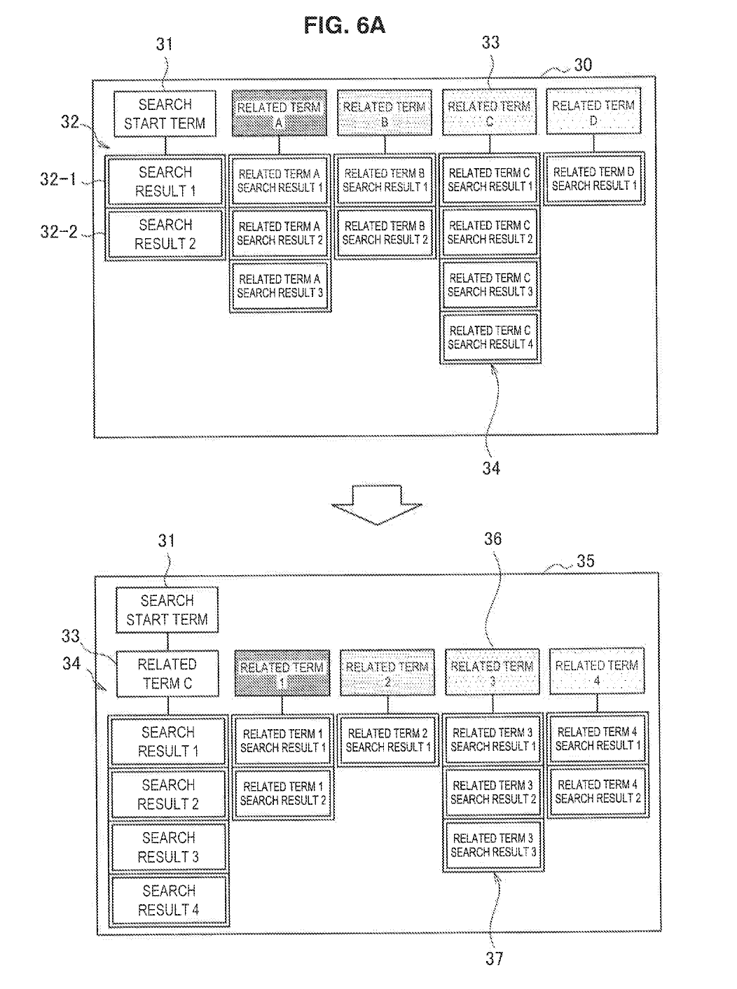

FIG. 6A and FIG. 6B are screen transition diagrams for describing the first specific example of the result display screen. The result display screen 30 of FIG. 6A is the result display screen controlled by the control section 12 (the display control section), when the search section 14 conducts the search based on the input term (hereinafter, also referred to as a search start term), and the search based on the related term corresponding to the search start term.

As illustrated in the result display screen 30 of FIG. 6A, the search result 32 based on the search start term 31 (the input term) is arranged and displayed with the search start term 31 at the head. Further, the search results based on each of the determined related terms A to D are arranged and displayed with each of the related terms A to D at the head.

Note that the arrangement order of each search result may be, for example, in the order of the broadcasting date and time, or in the order of the favorite genre value, or the like.

Here, the control section 12 (the display control section) may display the search result 32 (the search results 32-1, 32-2) based on the search start term 31 (the input term), and the search results based on each of the related terms A to D, in a different manner. For example, the control section 12 may display in such a manner that the search result 32 based on the search start term 31 is larger than the search results based on each of the related terms A to D, as illustrated in FIG. 6A.

Also, the control section 12 may control the displaying manner of the search result based on the related term, on the basis of the relation degree in relation to the search start term 31 (the input term) of the related term and the search hit number. Note that the relation degree in relation to the search start term 31 may be judged on the basis of the appearance number (or the appearance frequency rate) calculated by the term counting section 24, for example.

For example, as illustrated in FIG. 6A, the control section 12 may arrange and display each related term and its search result in descending order of the relation degree in relation to the search start term 31, or in the inverse order. Further, as illustrated in FIG. 6A, the control section 12 may display each related term in descending order of the relation degree from the deep color, or in the inverse order.

Also, the control section 12 may arrange and display each related term and its search result, in descending order of the search hit number. In this case, the control section 12 arranges and displays in the order of the related term C (4 hit), the related term A (3 hit), the related term B (2 hit), and the related term D (1 hit). Also, the control section 12 may arrange in ascending order of the search hit number.

Also, as described above, the result display screen according to the present embodiment doubles as the search term input interface. In other words, the user can point (input) any of the related terms A to D displayed on the result display screen 30 illustrated in FIG. 6A, as a new term (the input term) for the search.

For example, if the “related term C” 33 displayed on the result display screen 30 is pointed (step S118/Yes illustrated in FIG. 4), the information processing device 1 acquires the related term (indirectly related term) candidates related to the related term C from the server 2, and determines the indirectly related term for each user. Note that the extraction by the server 2 of the indirectly related term, and the determination of the indirectly related term by the information processing device 1 are in the same way as the extraction of the related term candidates, and the determination of the related term, which are described above.

Thereafter, the search section 14 of the information processing device 1 conducts the program search on the basis of the determined indirectly related term (the related terms 1 to 4), and outputs the search result to the control section 12.

Then, as illustrated in the result display screen 35 of FIG. 6A, the control section 12 displays, on one screen, the search result 34 based on the related term C, and the search results based on the indirectly related terms (the related terms 1 to 4).

Further, as illustrated in the result display screen 35 of FIG. 6A, the search start term 31 is displayed above the “related term C” 33. Thereby, the user can confirm the history of the terms used in the search.

Also, since the result display screen 35 illustrated in FIG. 6A doubles as the search term input interface, the information processing device 1 conducts the search on the basis of the related terms a to d related to the related term 3, when the “related term 3” 36 is pointed by the user, for example. Then, as illustrated in the result display screen 38 of FIG. 6B, the control section 12 displays, on one screen, the search result 37 of the related term 3, and the search results of the related terms a to d.

Also, as illustrated in the result display screen 38 of FIG. 6B, the search start term 31 used in the search of the past, and the “related term C” 33 are displayed above the “related term 3”36 in the temporal sequence.

In this way, the present embodiment realizes the consecutive search by the consecutive pointing of the term. Note that the user is also be able to point the search terms of the past, of which the history is displayed, so as to transit to the result display screen 30 of FIG. 6A, when the search start term 31 displayed on the result display screen 38 of FIG. 6B is pointed, for example.

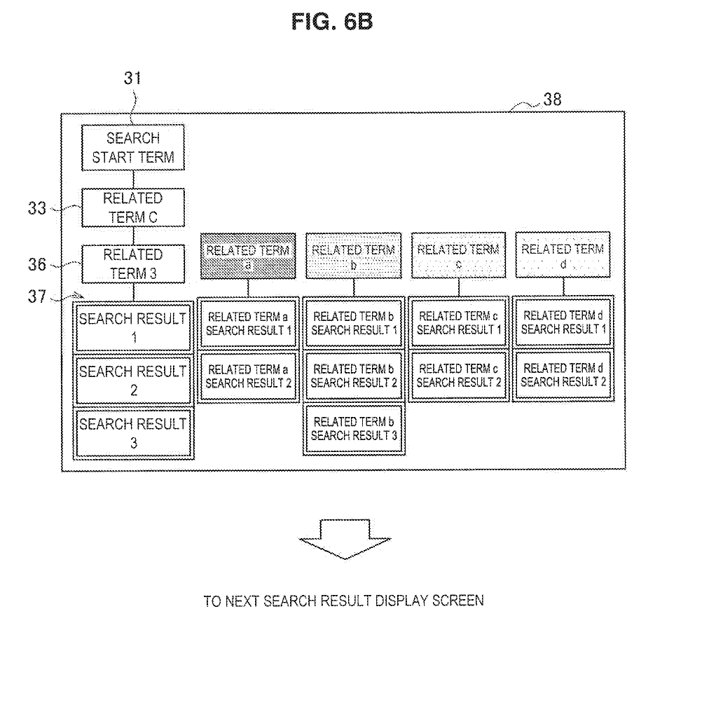

Also, in the present embodiment, the view and record reservation of the searched broadcast scheduled program, or the replay of the searched recorded program may be instructed from the search result displayed on the result display screen. Specifically, for example, as illustrated in FIG. 7, the search result 32-1 may include the program information (the text and the thumbnail image) of the searched broadcast scheduled program, and the reservation button 41 for accepting the reservation instruction. When the reservation button 41 is selected, the information processing device 1 conducts the record reservation of the broadcast scheduled program presented in the search result 32-1.

In the above, specific description has been made of the first specific example of the result display screen according to the present embodiment. Next, description will be made of the second specific example of the result display screen according to the present embodiment.

### 4-2. Second Specific Example

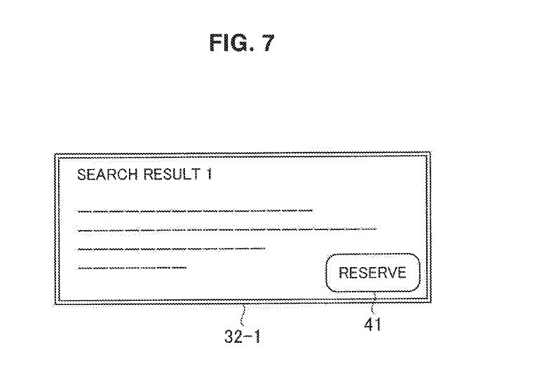

In the result display screen according to the second specific example, the search results and the related terms are displayed radially around the term used in the search. In the following, the second specific example in the state of the result display screen 35 illustrated in FIG. 6A described above (the state in which the “related term C” 33 is pointed as a new search term) is illustrated in FIG. 8.

As illustrated in FIG. 8, the related terms A to D are displayed radially, with the search start term 31 at the center. Further, since the “related term C” 33 is pointed as a new search term, the search results 34-1 to 34-4 based on the related term C, and the related terms 1 to 4 are displayed radially with the “related term C” 33 at the center, as illustrated in FIG. 8.

Note that the control section 12 may control the length of the distance (the line length) between a term and a term, according to the relation degree. For example, in the example illustrated in FIG. 8, the control section 12 displays in such a manner that the greater the relation degree is, the shorter the distance is, and the smaller the relation degree is, the longer the distance is. Also, the control section 12 may control the deepness of the color of the term according to the relation degree as well.

Also, the control section 12 may control the size of the term according to the search hit number. For example, in the example illustrated in FIG. 8, the control section 12 displays in such a manner that the more the search hit number is, the larger the term is, and the less the search hit number is, the smaller the term is.

Also, the control section 12 may display the number of the search result based on the term, as “number hit” together with the term. For example, as illustrated in FIG. 8, the control section 12 displays “4 hit” together with the search start term when the search results of the search start term numbers four, and displays “3 hit” together with the related term A when the search results of the related term A numbers three.

Also, as illustrated in FIG. 8, in the second specific example, the search start term 31 which is the search term of the past may be displayed. In this way, by displaying the history of the search term of the past, the search result display screen of the past can be tracked back to, when a search term of the past is pointed.

In the above, specific description has been made of the second specific example of the result display screen according to the present embodiment. Next, description will be made of the third specific example of the result display screen according to the present embodiment.

### 4-3. Third Specific Example

In the result display screen according to the third specific example, the search result based on the term, and the term related to the term are displayed in such a manner to be grasped intuitively.

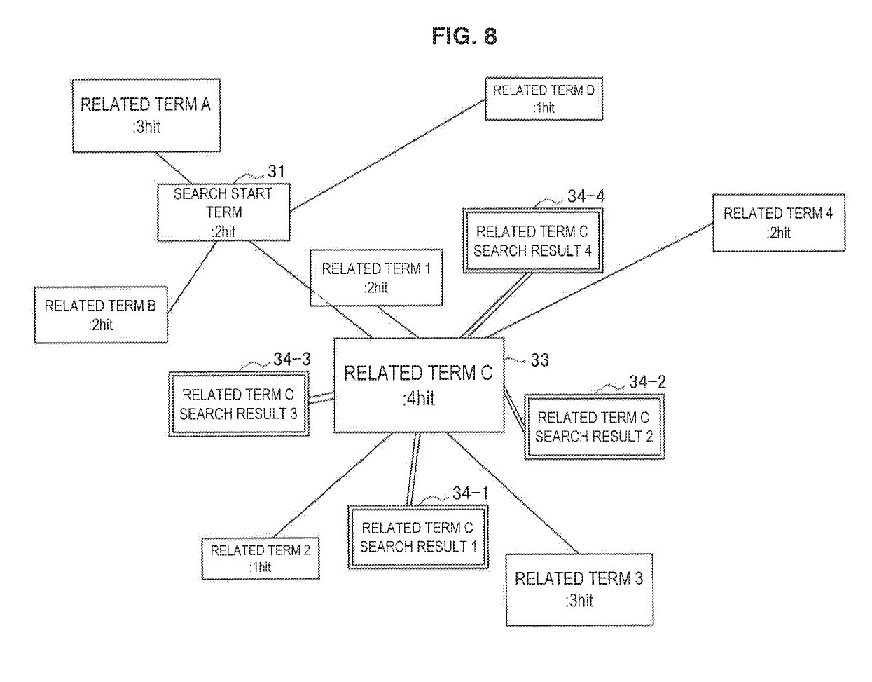

For example, as illustrated in FIG. 9, in the third specific example, a look-up box 60, which is a search term region, is displayed. Also, the related terms A to D corresponding to the search start term are displayed around the look-up box 60, for example.

When the “related term C” 33 is pointed as a new search term, the control section 12 (the display control section) controls the display in such a manner that the “related term C” 33 moves to the look-up box 50 (the search term region), as illustrated in the top of FIG. 9.

Then, the control section 12 controls the display in such a manner to change the display in the look-up box 50 from the search start term” to the “related term C”, as illustrated in the bottom of FIG. 9. Further, the control section 12 controls the display in such a manner that the search results 34-1 to 34-4 based on the related term C and the related terms (the indirectly related terms) 1 to 2 related to the related term C pop out from inside the look-up box 50 to expand radially.

Also, the control section 12 may control the size of the search result in the order of the search results 1 to 4, as illustrated in the bottom of FIG. 9. Also, the order of the search results 1 to 4 may be, for example, the order of the broadcasting date and time, the order of the favorite genre value, or the like.

In the above, specific description has been made of the third specific example of the result display screen according to the present embodiment. Next, description will be made of the fourth specific example of the result display screen according to the present embodiment.

### 4-4. Fourth Specific Example

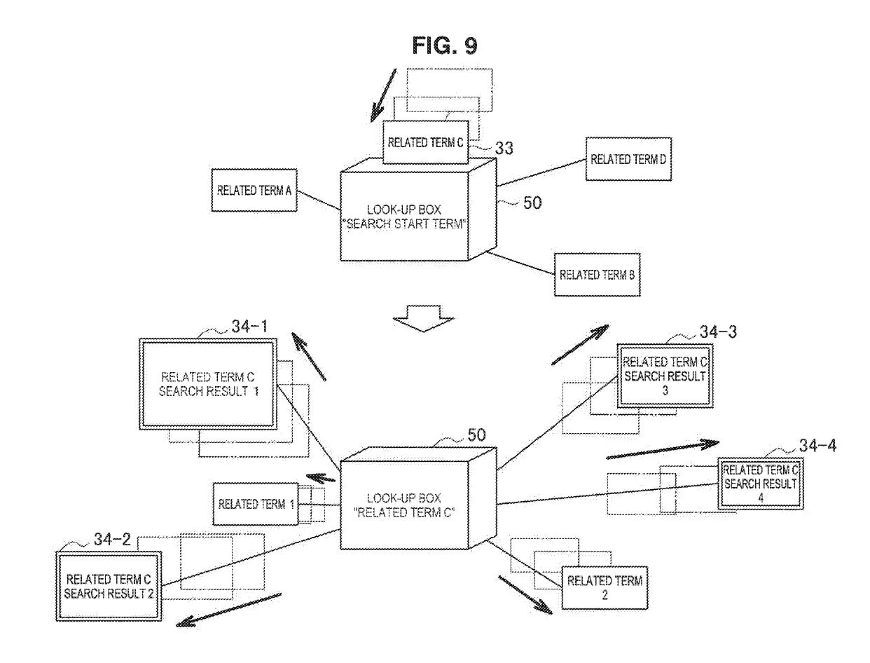

In the result display screen according to the fourth specific example, each search result is displayed by the multi-screen replay. For example, when the search results 44-1 to 44-4 of the “related term C” 33 are the recorded programs, the control section 12 (the display control section) controls to replay and display respective recorded programs of the search results 44-1 to 44-4 on the multi screens, as illustrated in FIG. 10.

Also, the control section 12 may control the size of the replay screen in the order of the search results 44-1 to 44-4. Also, the order of the search results 44-1 to 44-4 may be, for example, the order of the broadcasting date and time, the order of the favorite genre value, or the like.

In the above, specific description has been made of the fourth specific example of the result display screen according to the present embodiment. Next, description will be made of the fifth specific example of the result display screen according to the present embodiment.

### 4-5. Fifth Specific Example

In the result display screen according to the fifth specific example, the histories of the search terms (the terms used in the search) at the time of the consecutive search, and of the search result display screens are displayed in the temporal sequence.

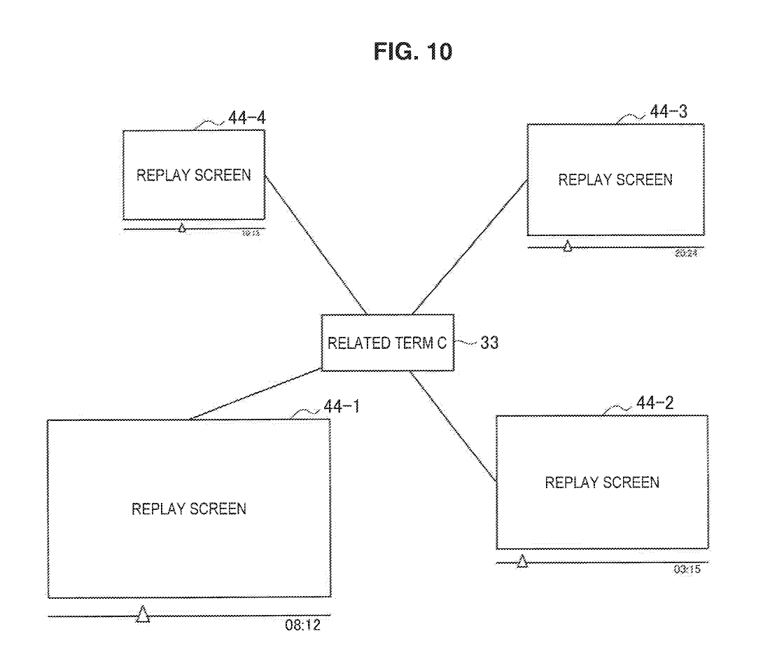

For example, description will be made of the fifth specific example of the result display screen of the state the “related term C” 33 is pointed as a new search term, from among the related terms A to D corresponding to the search start term (the input term) 31, with reference to FIG. 11.

FIG. 11 is a diagram illustrating the fifth specific example of the result display screen according to the present embodiment. As illustrated in FIG. 11, the search start term 31, the result display screen 61 including the search result of the search start term 31, the “related term C” 33, and the result display screen 63 including the search result of the “related term C” 33 are displayed on the Z axis as the search history.

In the example illustrated in FIG. 11, the closer to the origin, the more recent the search term (the term used in the search) and the result display screen are in the history. Also, since the histories of the search terms and the result display screens are displayed, the search and the display of the result display screen, which track back to the past, are enabled.

Also, in the example illustrated in FIG. 11, the result display screen 63 closest to the origin on the Z axis (the oblique axis) is displayed at the front of (on) the result display screen 61 of the past. For example, as illustrated in FIG. 11, in the result display screen 63 according to the fifth specific example, the related terms (the indirectly related terms) 1 to 4 related to the “related term C” 33 are displayed on the X axis, and the search results 1 to 4 based on the “related term C” 33 are displayed on the Y axis.

Also, as illustrated in FIG. 11, the X axis (the vertical axis) represents the relation degree in relation to the related term C, of each of the related terms 1 to 4, and the greater the relation degree is, the more adjacent to the related term C (the origin) the related term is displayed.

Also, as illustrated in FIG. 11, the Y axis (the lateral axis) represents the broadcasting date and time of each of the search results 1 to 4, and, for example, the closer to the origin, the closer to the present date and time the broadcasting date and time is.

Thereby, the user can intuitively recognize that the closer to the origin, the closer to the target (the search term) the program is so as to be viewed in the near future, on the basis of the spatial position relationship of each search result (the searched program) spread on the X axis and the Y axis.

In the above, specific description has been made of the first to fifth specific examples of the result display screen according to the present embodiment. Subsequently, supplement description will be made of the search system according to an embodiment of the present disclosure.

### <5. Supplement>

### [5-1. Share of Search Word History]

In the present embodiment, the history of the search terms stored in the search term history storage section 17 may be shared with other users.

The search term stored in the search term history storage section 17 is an input term that the user has input, and a related term customized and determined for each the user with respect to the input term, and therefore can be said to be a term reflecting the interest and preference of the user. Thereby, for example, by using the search term history of other users whose interest and preference is similar to the interest and preference of the user, a wide search more taking account of the preference of the user is realized.

### [5-2. Improvement of Program Data]

The related term determining section 13 according to the present embodiment may determine the related term on the basis of the subtitle data of the program stored in the program data storage section 16. Also, the search section 14 according to the present embodiment may search for the program using the subtitle data of the program stored in the program data storage section 16.

In this way, even in the area where the electronic program information is not continually delivered, the determination and the search of the related term are enabled using the subtitle data of the program, in order to enhance the accuracy of the search system.

### [5-3. Presentation of Search Start Term Candidates]

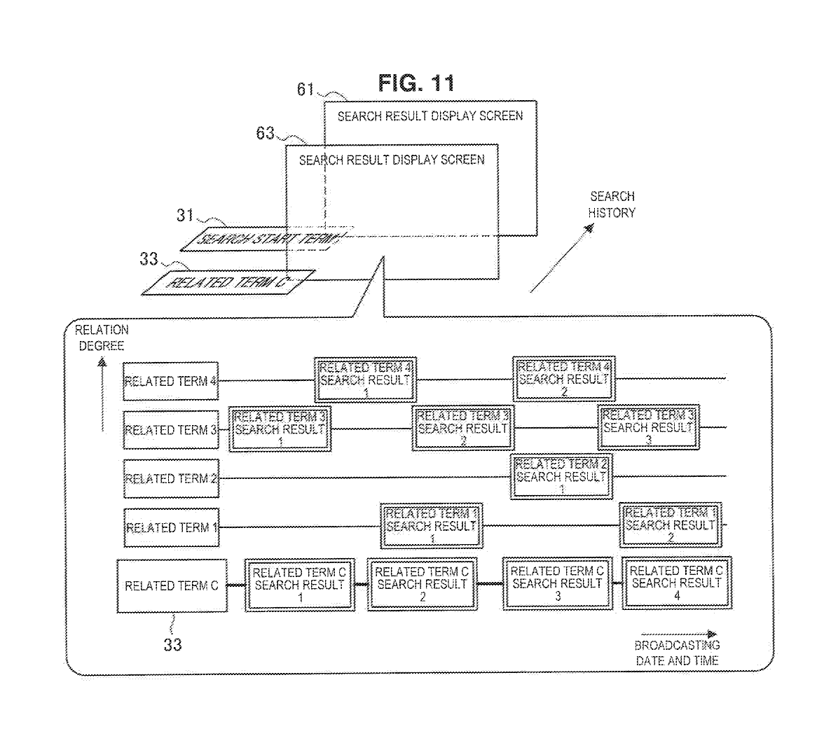

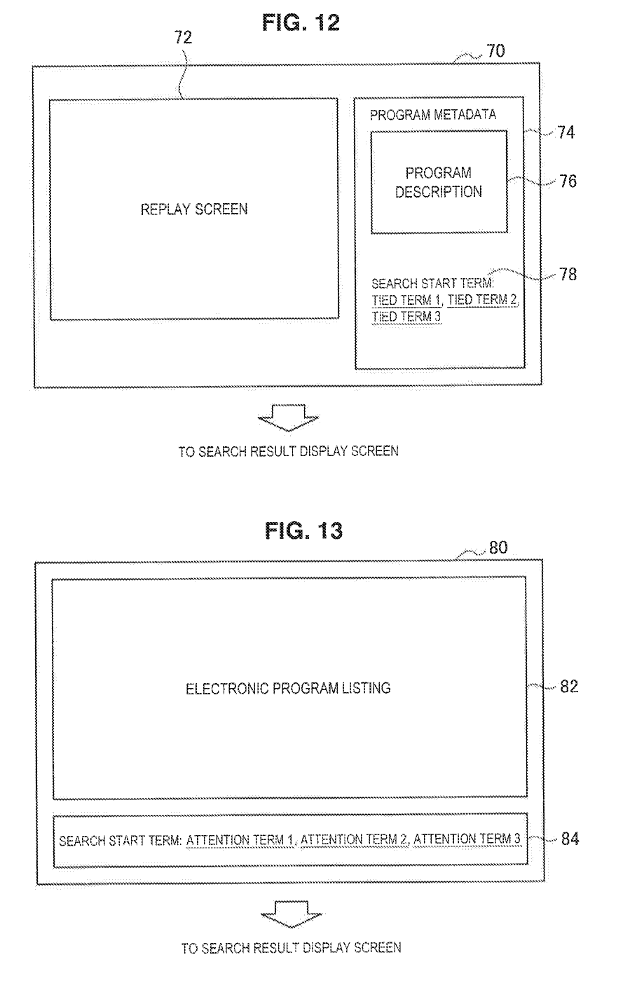

In the present embodiment, the search start term may be the input term that the user input on his or her own will, or may be the term that the user points from the search start term candidates presented by the information processing device 1. The presentation of the search start term candidates will be specifically described with reference to FIG. 12 and FIG. 13.

FIG. 12 is a diagram illustrating a candidate display example of the search start term based on the program metadata. As illustrated in FIG. 12, the display screen 70 includes the replay screen 72, and the program that the user is currently viewing is replayed. At this time, the program metadata display screen 74 displayed together with the replay screen 72 may display the program description 76 included in the program metadata of the program that is currently viewed.

Then, the control section 12 according to the present embodiment extracts the terms tied to the program from the program metadata of the program that is currently viewed, and displays the extracted tied terms as the candidates of the search start term. For example, as illustrated in FIG. 12, the display of the candidates (the tied terms) of the search start term may be displayed on the search start term display screen 78 in the program metadata display screen 74.

Thereby, the user can point (input) the search start term from the tied terms 1 to 3 displayed on the search start term display screen 78. Also, the information processing device 1 executes the search process (refer to “3-1. Search Process”) described above, using the pointed (input) term as the search start term, and controls to display the search result display screen.

FIG. 13 is a diagram illustrating a candidate display example of the search start term based on the attention term of the public. Here, the attention term of the public may be the term decided by counting the search term history of a plurality of users. The control section 12 of the information processing device 1 according to the present embodiment can display the attention terms as the candidates of the search start term, regardless of the data the user is currently viewing.

For example, as illustrated in FIG. 13, while the electronic program listing 82 that the user is currently viewing is displayed on the display screen 80, the control section 12 displays the attention terms 1 to 3, which are the candidates of the search start term, on the search start term display screen 84, irrespective of the content of the electronic program listing 82.

Thereby, the user can point (input) the search start term from the attention terms 1 to 3 displayed on the search start term display screen 84. Also, the information processing device 1 executes the search process (refer to “3-1. Search Process”) described above, using the pointed (input) term as the search start term, and controls to display the search result display screen.

### [5-4. Improvement of System Configuration]

In the search system illustrated in FIG. 1 described above, the server 2 that connects with the information processing device 1 via the network 3 extracts the related term candidates, but the configuration of the search system according to the present disclosure is not limited to this. For example, the control section 12 of the information processing device 1 may conduct the process to extract the related term candidates by the specific algorithm, using the mass data on the network. Thereby, the update of the utilized mass data becomes easy, and in addition the newest mass data can be used.

<6. Conclusion>

As described above, the search system according to the present embodiment can customize for each user (user), and determine, the related term corresponding to the input term.

Thereby, even under the situation where the targeted program is unclear, the effective program search system is realized. Also, by using the related term related to the input term for the search, the program that has been unable to be searched for in the normal program search system can be searched for.

Also, since the server 2 executes the extraction of the related term candidates from the extraction source of the mass data on the server, the data update is facilitated, and the newest term of the public is reflected on the related term candidates.

Also, since the information processing device 1 (the client terminal) executes the determination of the related term candidates, using the user specific data, the related term optimized for the utilization of the individual users is determined.

The preferred embodiments of the present invention have been described above with reference to the accompanying drawings, whilst the present invention is not limited to the above examples, of course. A person skilled in the art may find various alterations and modifications within the scope of the appended claims, and it should be understood that they will naturally come under the technical scope of the present invention.

For example, in the embodiment described above, the search objects are the broadcast scheduled programs and the recorded programs, but the search objects of the search system according to the present disclosure are not limited to this. Various content data such as still images, moving images, text information, games, and applications may be the search objects.

Additionally, the present technology may also be configured as below.

(1)

An information processing device including:

a storage section;

a candidate acquiring section configured to acquire candidates of a related term corresponding to an input term; and

a related term determining section configured to determine the related term from the candidates of the related term on basis of information stored in the storage section.

(2)

The information processing device according to (1), wherein

the information processing device further includes a search section configured to conduct a search based on the input term and the related term determined by the related term determining section.

(3)

The information processing device according to (2), wherein

the information processing device further includes a display control section configured to control a display of the input term and the determined related term, and a display of a search result by the search section.

(4)

The information processing device according to (3), wherein

the display control section generates a first result display screen including a display presenting each of the input term, the search result based on the input term, the related term, and the search result based on the related term.

(5)

The information processing device according to (4), wherein

the display control section generates the display presenting the search result based on the input term, in a different manner from the display presenting the search result based on the related term.

(6)

The information processing device according to (5), wherein

the display presenting one search result based on the input term is larger than the display presenting one search result based on the related term.

(7)

The information processing device according to any one of (4) to (6), wherein

the search result based on the input term is displayed with the input term arranged at a head, and

the search result based on the related term is displayed with the related term arranged at a head.

(8)

The information processing device according to any one of (4) to (6), wherein

the search result based on the input term is displayed radially with the input term at a center, and

the search result based on the related term is displayed radially with the related term at a center.

(9)

The information processing device according to any one of (4) to (8), wherein

the search section conducts a search based on the indirectly related term related to the related term when the related term is selected in the first result display screen, and

the display control section generates a second result display screen including displays presenting each of the related term, the search result based on the related term, the indirectly related term, and the search result based on the indirectly related term.

(10)

The information processing device according to (9), wherein

the display control section generates a display presenting a history of the terms used in the search by the search section.

(11)

The information processing device according to (9), wherein

the display control section generates a display presenting a history of result display screens including the displays of the search results.

(12)

The information processing device according to any one of (4) to (6), wherein

the display control section displays the related term in such a manner to move to a search term region when the related term is selected, and then displays the search result based on the related term in such a manner that the search result expands radially from the search term region.

(13)

The information processing device according to any one of (3) to (12), wherein

the display control section displays the search result by at least a character, a thumbnail image, or a moving image.

(14)

The information processing device according to (13), wherein

the display control section displays a plurality of the search results by multi-screen replay.

(15)

The information processing device according to any one of (1) to (14), wherein

the candidate acquiring section extracts data including the input term from mass data, and acquires terms appearing in the extracted data as the candidates of the related term in accordance with an acquirement condition.

(16)

The information processing device according to any one of (1) to (14), wherein

the candidate acquiring section acquires the candidates of the related term by an inquiry to an external device.

(17)

The information processing device according to any one of (1) to (16), wherein

the storage section stores user specific information, and

the related term determining section determines the related term on the basis of the user specific information stored in the storage section.

(18)

An information processing method including:

a step of acquiring candidates of a related term corresponding to an input term, and

a step of determining the related term from the candidates of the related term on the basis of information stored in a storage section.

(19)

A program for causing a computer to function as:

a storage section;

a candidate acquiring section configured to acquire candidates of a related term corresponding to an input term; and

a related term determining section configured to determine the related term from the candidates of the related term on basis of information stored in the storage section.

### REFERENCE SIGNS LIST

1 information processing device
2 server
3 network
11 manipulation section
12 control section
13 related term determining section
14 search section
15 user data storage section
16 program data storage section
17 search term history storage section
18 communication section
19 display section
21 control section
22 mass data search section
23 term extraction section
24 term counting section
25 related-term-extraction-dedicated mass data storage section
26 extraction term storage section
28 communication section

1. An information processing device comprising:
a storage section;
a candidate acquiring section configured to acquire candidates of a related term corresponding to an input term; and
a related term determining section configured to determine the related term from the candidates of the related term on basis of information stored in the storage section.

2. The information processing device according to claim 1, wherein
the information processing device further includes a search section configured to conduct a search based on the input term and the related term determined by the related term determining section.

3. The information processing device according to claim 2, wherein
the information processing device further includes a display control section configured to control a display of the input term and the determined related term, and a display of a search result by the search section.

4. The information processing device according to claim 3, wherein
the display control section generates a first result display screen including a display presenting each of the input term, the search result based on the input term, the related term, and the search result based on the related term.

5. The information processing device according to claim 4, wherein
the display control section generates the display presenting the search result based on the input term, in a different manner from the display presenting the search result based on the related term.

6. The information processing device according to claim 5, wherein
the display presenting one search result based on the input term is larger than the display presenting one search result based on the related term.

7. The information processing device according to claim 4, wherein
the search result based on the input term is displayed with the input term arranged at a head, and
the search result based on the related term is displayed with the related term arranged at a head.

8. The information processing device according to claim 4, wherein
the search result based on the input term is displayed radially with the input term at a center, and
the search result based on the related term is displayed radially with the related term at a center.

9. The information processing device according to claim 4, wherein
the search section conducts a search based on the indirectly related term related to the related term when the related term is selected in the first result display screen, and
the display control section generates a second result display screen including displays presenting each of the related term, the search result based on the related term, the indirectly related term, and the search result based on the indirectly related term.

10. The information processing device according to claim 9, wherein
the display control section generates a display presenting a history of the terms used in the search by the search section.

11. The information processing device according to claim 9, wherein
the display control section generates a display presenting a history of result display screens including the displays of the search results.

12. The information processing device according to claim 4, wherein
the display control section displays the related term in such a manner to move to a search term region when the related term is selected, and then displays the search result based on the related term in such a manner that the search result expands radially from the search term region.

13. The information processing device according to claim 3, wherein
the display control section displays the search result by at least a character, a thumbnail image, or a moving image.

14. The information processing device according to claim 13, wherein
the display control section displays a plurality of the search results by multi-screen replay.

15. The information processing device according to claim 1, wherein
the candidate acquiring section extracts data including the input term from mass data, and acquires terms appearing in the extracted data as the candidates of the related term in accordance with an acquirement condition.

16. The information processing device according to claim 1, wherein
the candidate acquiring section acquires the candidates of the related term by an inquiry to an external device.

17. The information processing device according to claim 1, wherein
the storage section stores user specific information, and
the related term determining section determines the related term on the basis of the user specific information stored in the storage section.

18. An information processing method comprising:
a step of acquiring candidates of a related term corresponding to an input term; and
a step of determining the related term from the candidates of the related term on the basis of information stored in a storage section.

19. A program for causing a computer to function as:
a storage section;
a candidate acquiring section configured to acquire candidates of a related term corresponding to an input term; and
a related term determining section configured to determine the related term from the candidates of the related term on basis of information stored in the storage section.
